(19) United States
(12) Patent Application Publication
(10) Pub. No.: US 2013/0104380 A1
(43) Pub. Date: May 2, 2013

(54) CUTTING MACHINE AND METHOD FOR CARRYING OUT CUTTING WORK ON FLAT, FLEXIBLE OR OTHER MATERIALS

(71) Applicant: Matthias Felber, Wolferstadt (DE)

(72) Inventor: Matthias Felber, Wolferstadt (DE)

(73) Assignee: Matthias Felber, Wolferstadt (DE)

(21) Appl. No.: 13/641,618

(22) PCT Filed: Apr. 11, 2011
(86) PCT No.: PCT/EP2011/055619

§ 371 Date: Jan. 2, 2013

(30) Foreign Application Priority Data
Apr. 16, 2010 (DE) 102010016479.8

(51) Int. Cl. C14B 1/00

(52) U.S. Cl. CPC C14B 1/00
USPC 29/557; 29/650

(57) ABSTRACT

A cutting machine and a method for cutting pieces of material using at least two cutting devices, which carry out cutting work simultaneously. The cutting devices are operated such that, when the cutting devices are operated simultaneously, each of the cutting devices carries out the respective cutting work on a different piece of material, and each of the cutting devices only carries out a respective portion of the cutting work to be carried out on a piece of material.

The present invention relates to a method according to the preamble of patent claim 1 and to a cutting machine according to the preamble of patent claim 12.

In the example under consideration, the materials to be cut by the cutting machine are flat, flexible materials, such as for example, but by no means exclusively, fabrics, leather, skins, paper, films, cork, rubber, felts, etc.

Parts of predetermined sizes and shapes are generally cut out from the material to be cut, preferably under computer control. The cutting out is performed by a cutting device, which may operate on the basis of a wide variety of principles, for example using a drawing blade, a circular blade, an oscillating blade, which carries out upward and downward movements, a high-frequency blade, the frequency of which may go into the ultrasound range, a water jet, a laser, or a plasma cutter.

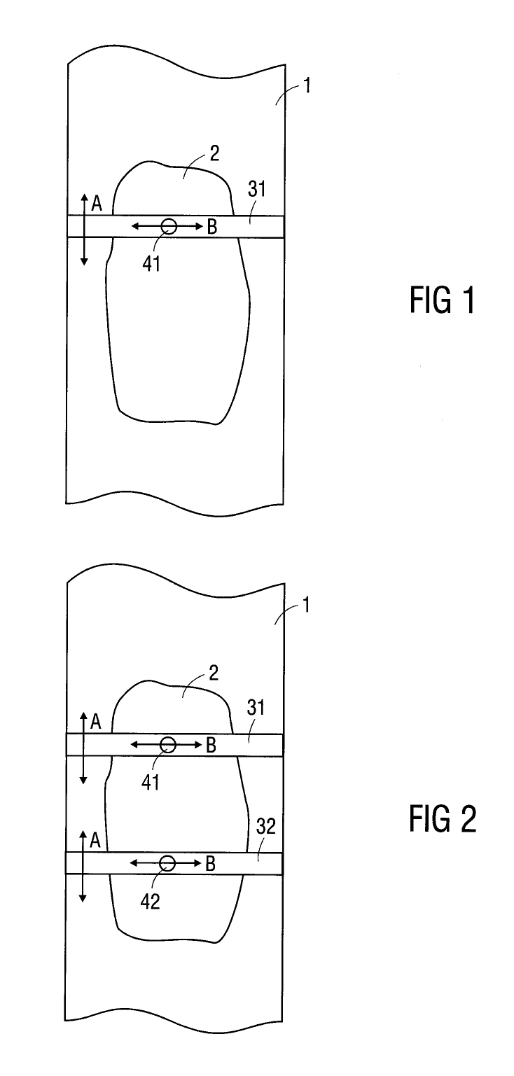

The basic structure of such a known cutting machine is schematically shown in FIG. 1. The cutting machine shown in FIG. 1 includes a supporting surface 1, a bridge 31, which is displaceable along a double-headed arrow A, that is to say along the supporting surface 1 in relation thereto, and a cutting device 41, which is arranged on the bridge 31 and is displaceable along a double-headed arrow B, that is to say transversely to the direction of movement A of the bridge 31 in relation thereto.

The material to be cut by the cutting machine has to be placed onto the supporting surface 1. In the example under consideration, it is a piece of leather, denoted by the reference numeral 2.

Then, any desired number of parts of any size and any shape can be cut out from the piece of leather 2, from any locations of the piece of leather 2, by a corresponding movement of the bridge 31 and of the cutting device 41. The movement of the bridge 31 and the cutting device 41 is generally controlled by a computer.

The decision establishing which parts are to be cut out from where in the piece of leather is usually likewise at least partly taken by a computer. For this purpose, firstly the position of the piece of leather 2 on the supporting surface 1, the shape and size of the piece of leather 2, and the position, shape and size of imperfections and/or various quality zones on the piece of leather 2 are determined. These determinations may be at least partially made fully automatically using a scanner. In the case of the imperfections and quality zones, it may however prove to be advantageous if they are identified manually by a person, and then only the markings present on the piece of leather are automatically recorded and evaluated. Then, taking the aforementioned information into consideration, the computer establishes which parts are to be cut and from where in the piece of leather (nesting), it preferably being ensured that the parts to be cut out are optimally nested, that is to say as little material as possible remains unused. Subsequently, the computer then also automatically generates the cutting pattern, corresponding to which the bridge 31 and the cutting device must be moved during the cutting of the material.

Such cutting machines are often also referred to by those skilled in the art as cutters.

It should be obvious and needs no further explanation that there is an interest in cutting a wide variety of materials as quickly as possible with minimal material consumption.

For this purpose, it may be envisaged to increase the cutting speed. However, the cutting speed cannot be set to any speed whatsoever. If the speed is too high, the material is no longer cut correctly, or the material is displaced during cutting, whereby the cut-out parts no longer have the required dimensions, and consequently are no longer usable.

Furthermore, it may be envisaged to carry out the preparatory work (recording the position and the contour of the material to be cut and the imperfections and quality zones) not in the cutting station shown in FIG. 1 but in a separate scanner/nesting station. Then, during the cutting of a leather hide 2 in the cutting station, the preparatory work for the next leather hide 2 to be cut may already be carried out in the separate scanner/nesting station. This has the positive effect that cutting can be performed almost uninterruptedly in the cutting station. This applies in particular whenever the scanner/nesting station, the cutting station, and preferably a clearing station, in which the cut-out parts and the remnants are removed and sorted, are arranged in a series at equal intervals between them, and the material to be cut lies on a cutting-resistant conveyor belt, which when required transports it further to the next working station respectively. However, even with such an arrangement, it would be desirable if the cutting performed in the cutting station could be accomplished in a still shorter time.

One possibility for this is that a plurality of cutting devices are provided. An example of such a cutting machine or cutting station is illustrated in FIG. 2. The cutting machine shown in FIG. 2 largely corresponds to the cutting machine shown in FIG. 1. The only difference is that the cutting machine represented in FIG. 2 additionally includes a second bridge 32 and a second cutting device 42 provided on the latter, which can be moved like the first bridge 31 and like the first cutting device 41. In the case of this cutting machine, therefore, two cutting devices can simultaneously cut out the parts to be cut out from a leather hide 2.

The doubling of the number of cutting devices that work simultaneously on a leather hide does not, however, lead to a halving of the time required for the cutting. The reason for this is that the cutting devices 41, 42 and/or the bridges 31, 32 carrying them may interfere with one another. To be more specific, it must be prevented that the cutting devices 41, 42 and/or the bridges 31, 32 carrying them collide, causing recurrent instances where one of the cutting devices must idly wait because it would otherwise collide with the other cutting device.

The present invention is therefore based on the object of developing the method according to the preamble of patent claim 1 and the cutting machine according to the preamble of patent claim 12 with little additional effort in such a way that a higher cutting performance can be achieved.

This object is achieved according to the invention by the method claimed in patent claim 1 and the cutting machine claimed in patent claim 12.

The method according to the invention is distinguished by the aspects
that, when the cutting devices are operated simultaneously, each cutting device carries out its cutting work on a different piece of material and
that each of the cutting devices respectively carries out only part of the cutting work to be carried out on a piece of material.

The cutting machine according to the invention is distinguished by the fact that it works on the basis of this method.

Since a plurality of cutting devices cut simultaneously, but it is never the case that a plurality of cutting devices work simultaneously on one piece of material, and there is consequently no risk of collisions of the cutting devices and/or of the cutting machine components carrying them, the cutting devices can be used particularly efficiently. In particular, a significantly higher cutting performance can be achieved in this way.

Advantageous developments of the invention are the subject of the subclaims.

The invention is explained in more detail below on the basis of an exemplary embodiment and with reference to the figures, in which:

FIG. 1 shows the first conventional cutting machine already described at the beginning, in a plan view from above,

FIG. 2 shows the second conventional cutting machine already described at the beginning, in a plan view from above, and

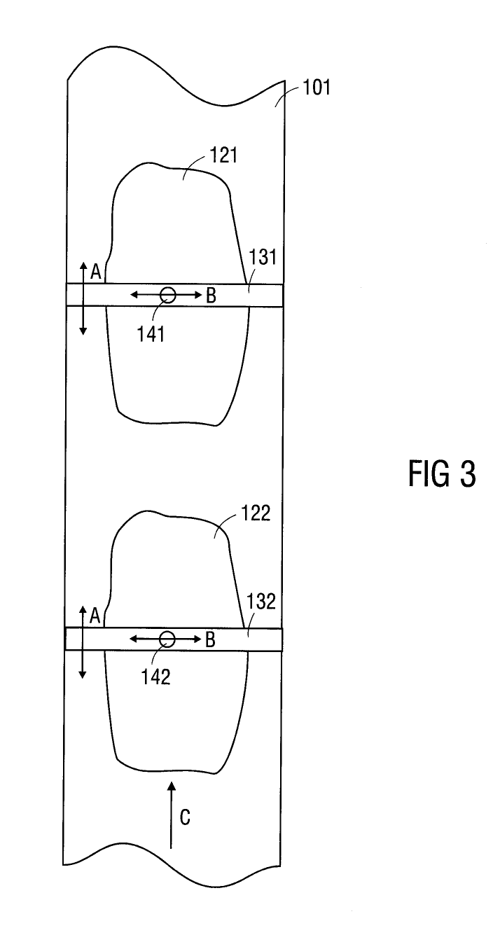

FIG. 3 shows a cutting machine described in more detail below, in a plan view from above.

Like the conventional cutting machine described at the beginning, the cutting machine presented here is a cutting machine for cutting flat, flexible materials such as for example, but by no means exclusively, fabrics, leather, skins, paper, films, cork, rubber, felts, etc. The cutting machine presented here may, however, also be a cutting machine for cutting any other desired materials, for example for cutting marble slabs or other non-flexible materials.

The basic structure of the cutting machine presented here is schematically shown in FIG. 3. The cutting machine shown in FIG. 3 includes a supporting surface 101, a first bridge 131, which is displaceable along a double-headed arrow A, that is to say along the supporting surface 101 in relation to the supporting surface 101, a first cutting device 141, which is arranged on the first bridge 131 and is displaceable along a double-headed arrow B, that is to say transversely to the direction of movement A of the first bridge 131 in relation to the first bridge 131, a second bridge 132, which is displaceable along a double-headed arrow A, that is to say along the supporting surface 101 in relation to the supporting surface 101, and a second cutting device 142, which is arranged on the second bridge 132 and is displaceable along a double-headed arrow B, that is to say transversely to the direction of movement A of the second bridge 132 in relation to the second bridge 132.

The supporting surface 101 is preferably a cutting-resistant conveyor belt, but could also be a tabletop or the like.

The cutting devices 141, 142 may work on the basis of any desired principles, for example using a drawing blade, a circular blade, an oscillating blade, which carries out an upward and downward movement, a high-frequency blade, the frequency of which may go into the ultrasound range, a water jet, a laser, or a plasma cutter.

The material to be cut by the cutting machine has to be placed onto the supporting surface 101. As still to be explained in more detail below, in the case of the machine presented here the cutting devices 141, 142 that are present never work on the same piece of material simultaneously. In the example under consideration, and in the state shown in FIG. 3, the first cutting device 141 is in the process of cutting out parts from a first piece of material 121, and the second cutting device 142 is simultaneously cutting out parts from a second piece of material 122. The material to be processed by the cutting machine presented here therefore consists of a plurality of pieces of material, in the example under consideration one piece of material for each cutting device that is present. These pieces of material, denoted by the reference numerals 121 and 122, have been placed onto the supporting surface 101.

In the example under consideration, the pieces of material 121 and 122 are respectively a piece of leather, for example in each case a complete cowhide.

The controllable components of the cutting machine (the cutting devices 141, 142, the bridges 131, 132, the conveyor belt and optionally further cutting machine components) are controlled by a computer belonging to the cutting machine or by a separate computer. This will be discussed more precisely later.

The decision establishing which parts are to be cut out from where in the pieces of material is usually likewise at least partly taken by a computer. For this purpose, firstly the position of the piece of material on the supporting surface 101, the shape and size of the piece of material, and the position, shape and size of imperfections and/or various quality zones on the piece of material concerned are determined for each piece of material. These determinations may be at least partially made fully automatically using a scanner, this scanner preferably being arranged in a separate scanner/nesting station that is provided upstream adjacent to the arrangement shown in FIG. 3. In the case of the imperfections and quality zones, it may however prove to be advantageous if they are identified manually by a person, and then only the markings present on the piece of leather are automatically recorded and evaluated. Then, taking the aforementioned information into consideration, the computer establishes which parts are to be cut and from where in the piece of leather (nesting), it preferably being ensured that the parts to be cut out are optimally nested, that is to say as little material as possible remains unused. Subsequently, the computer then also automatically generates the cutting pattern, corresponding to which the bridge 31 and the cutting device must be moved during the cutting of the material.

It should be mentioned for the sake of completeness that a separate clearing station is also provided, in which the cut-out parts and remnants are removed and sorted, and which is arranged downstream adjacent to the arrangement shown in FIG. 3.

If, in addition to the arrangement shown in FIG. 3, a separate scanner/nesting station and/or a separate clearing station is provided, which, as already mentioned above, is preferably the case, the conveyor belt forming the supporting surface 101 preferably extends over the entire (extended) arrangement, that is to say all of the working stations that are present.

As a result of the mobility of the cutting devices 141 and 142 and of the bridges 131 and 132 carrying them, there is for each cutting device a region within which the respective cutting device can be moved and can cut out parts from a piece of material coming to lie in it. These regions are referred to hereafter as cutting regions. To be more precise, the region within which the first cutting device 141 can cut is referred to as the first cutting region, and the region within which the second cutting device 142 can cut is referred to as the second cutting region.

The cutting regions are preferably of such a size that a suitable piece of material can be accommodated completely in each cutting region.

The cutting machine is preferably formed in such a way that the first cutting region of the first cutting device 141 and the second cutting region of the second cutting device 141 do not overlap. Preferably, the cutting regions are even kept at such a distance from one another that it is not even theoretically possible for a collision of the cutting devices 141, 142 and/or the bridges 131, 132 to occur.

The cutting devices 141, 142 and the bridges 131, 132 can consequently be moved as desired completely independently of one another. An appropriate movement of the bridges 131, 132 and of the cutting devices 141, 142 allows any desired number of parts of any size and any shape to be cut simultaneously from any locations of the pieces of material independently of one another in the cutting regions.

The cutting machine is additionally activated in such a way that the cutting devices 141, 142 respectively work on different pieces of material, and that the cutting work to be performed on a respective piece of material is performed partly by the first cutting device 141, and partly by the second cutting device 142.

To be more precise, in the example under consideration the cutting process proceeds more specifically as follows.

Let us assume that at first there is not yet any piece of material 121, 122 to be cut on the supporting surface 101, at least in the region of the supporting surface that is shown in FIG. 3. Let us also assume that the conveyor belt that serves as the supporting surface 101 for the pieces of material and for transporting the pieces of material is moving from the bottom upward—with respect to the representation in FIG. 3—that is to say as indicated by the arrow C.

By putting into operation the conveyor belt serving as the supporting surface 101, the first piece of material 121 is then brought into the cutting region of the second cutting device 142. When the first piece of material 121 has reached its intended position, the conveyor belt is stopped again. In this state, the first piece of material 121 is then located where the second piece of material 122 is depicted in FIG. 3, and there is then no piece of material where the first piece of material 121 is depicted in FIG. 3.

Then the second cutting device 142 begins to cut out the parts to be cut out from the first piece of material 121. However, the second cutting device 142 does not cut out all of the parts to be cut out from the first piece of material 121. Since there is no piece of material to be cut out in the cutting region of the first cutting device 141, the first cutting device 141 in this stage does not carry out any cutting operation.

Subsequently, the conveyor belt is put into operation again, whereby the first piece of material 121 arrives in the cutting region of the first cutting device 141, that is to say for example at the position of the first piece of material 121 that is depicted in FIG. 3. This is accompanied by the conveyor belt bringing the second piece of material 122 that has already been placed on it in advance into the cutting region of the second cutting device 142, that is to say for example to the position of the second piece of material 122 that is depicted in FIG. 3. After that, the conveyor belt is stopped again. In this state, the first piece of material 121 and the second piece of material 122 are then where they are depicted in FIG. 3.

Then both cutting devices 141, 142 are put into operation. The first cutting device 141 is activated in such a way that it carries out the cutting work to be performed on the first piece of material 121 that was not previously performed by the second cutting device 142. At the same time, the second cutting device 142 cuts out parts to be cut out from the second piece of material 122. However, once again, the second cutting device 142 does not cut out all of the parts to be cut out from the second piece of material 122. The remaining cutting work is once again carried out later by the first cutting device 141. After completion of this working step, all of the parts to be cut out have been cut out from the first piece of material 121, that is to say all of the cutting work to be carried out has been completed, whereas further cutting work still has to be carried out later on the second piece of material 122 by the first cutting device 141.

Subsequently, the conveyor belt is put into operation again, whereby the first piece of material 121 is transported out of the region of the cutting machine that is shown in FIG. 3. Preferably, the first piece of material 121 thereby arrives in a clearing station (not shown in the figures), in which the parts to be cut out and the remaining remnant of the first piece of material can be removed from the conveyor belt and sorted. This is accompanied by the second piece of material 122 arriving in the cutting region of the first cutting device 141, that is to say for example at the position of the first piece of material 121 that is depicted in FIG. 3. This is accompanied by the conveyor belt bringing a third piece of material that has already been placed on it in advance into the cutting region of the second cutting device 142, that is to say for example to the position of the second piece of material 122 that is depicted in FIG. 3. After that, the conveyor belt is stopped again. In this state, the second piece of material 122 and the third piece of material are then where the first piece of material 121 and the second piece of material 122 are depicted in FIG. 3.

Then both cutting devices 141, 142 are put into operation again. The first cutting device 141 is activated in such a way that it carries out the cutting work to be performed on the second piece of material 122 that was not previously performed by the second cutting device 142. At the same time, the second cutting device 142 cuts out parts to be cut out from the third piece of material. However, once again, the second cutting device 142 does not cut out all of the parts to be cut out from the third piece of material. The remaining cutting work is once again carried out later by the first cutting device 141. After completion of this working step, all of the parts to be cut out have been cut out from the second piece of material 122, that is to say all of the cutting work to be carried out has been completed, whereas further cutting work still has to be carried out later on the third piece of material.

Subsequently, the conveyor belt is put into operation again to transport the pieces of material further, then they are cut again when the conveyor belt has been stopped, and so on.

As already indicated above, it is decided by a computer which cutting device has to carry out which cutting work. The cutting work to be carried out on a piece of material is preferably divided between the plurality of cutting devices in such a way
that, of the cutting work to be carried out on a piece of material, the cutting work that is not carried out by one cutting device is or has been carried out by the other cutting devices, and/or
that each of the cutting devices carries out part of the cutting work to be carried out on a piece of material,
that the cutting devices are operated in such a way that as many cutting devices as possible work simultaneously,
that the cutting devices are operated in such a way that the cutting devices work simultaneously for as long as possible,
that the extent of the cutting work to be carried out simultaneously by the cutting devices differs as little as possible,
that the dividing of the cutting work that each cutting device has to carry out on the pieces of material to be cut at a given time is based on the cutting work that is to be carried out on the pieces of material being processed at the time by the cutting devices,
that the dividing of the cutting work that each cutting device has to carry out on the pieces of material to be cut at a given time is based on the cutting work that is to be carried out on the next piece of material or the next pieces of material that is or are to be processed after the pieces of material being processed at the time by the cutting devices,
that the cutting work to be carried out on a piece of material is divided evenly between the cutting devices,
that the cutting work to be carried out on a piece of material is divided unevenly between the cutting devices, and/or
that the cutting devices are moved independently of one another.

The cutting machine presented here and the method presented here can be modified in many different ways.

For example, there is no restriction to the provision of precisely two cutting devices. In principle it is also possible for any desired greater number of cutting devices to be provided.

Furthermore, there is also no necessity to arrange the cutting devices as in the example under consideration (on bridges 131, 132). The cutting devices may also be arranged on any other desired cutting machine components, for example also on a robot arm.

The cutting machine presented here also proves to be advantageous when cutting roll stock. This involves carrying out cutting work simultaneously at different regions of the web of material by the at least two cutting devices 141, 142, these material regions like the plurality of pieces of material 121, 122 or like the cutting regions of the plurality of cutting devices 141, 142 being arranged regions of the roll stock and also being handled in just the same way as the plurality of pieces of material 121, 122 with respect to the cutting work to be carried out. This means, inter alia,
that, with simultaneous operation of the cutting devices 141, 142, each cutting device carries out its cutting work at a different material region, and
that each of the cutting devices 141, 142 respectively carries out only part of the cutting work to be carried out at a material region.

The roll stock may therefore be regarded as a number of pieces of material that are connected to one another.

Irrespective of this, there is no absolute necessity to carry out in the way described above the preparatory work to be carried out before the cutting, that is to say the determination of the position of a respective piece of material on the supporting surface 101, the shape and size of the piece of material, the position, shape and size of imperfections and/or the various quality zones on the piece of material concerned, and the nesting of the parts to be cut out. In particular, instead of the mentioned fully automatic nesting by a computer, it is also possible to perform manual nesting, in which the user himself carries out the nesting on a monitor or using a video projector or laser projector projecting patterns and/or other information onto the respective piece of material, or in any other manner desired. Also possible are mixed forms, in which the computer makes a nesting proposal and the user can make changes, or in which the nesting is performed partly manually by the user (for specific parts to be cut out or for specific regions of the piece of material) and partly automatically by a computer (for the remaining parts to be cut out or the remaining regions of the piece of material). The same applies correspondingly to the determination of the position of a respective piece of material on the supporting surface 101, the shape and size of the piece of material, the position, shape and size of imperfections and/or the various quality zones on the piece of material concerned. The work required for this may also be carried out manually by the user or automatically by a computer, or partly manually by the user and partly automatically by a computer.

Furthermore, it may be provided that the conveyor belt is not stationary during the cutting, but is moved continuously, so that the cutting devices that are present can cut uninterruptedly. It may additionally be envisaged here to vary the speed of the conveyor belt on the basis of the cutting work to be carried out at a given time and/or other parameters, to be precise for example in such a way that, at each point in time, as many cutting devices as possible can cut at as high a speed as possible.

The same principle as when cutting may also be used when clearing the cut-up pieces of material. That is to say, two or more clearing stations lying one behind the other may be provided, each clearing station including a clearing device of its own, and these clearing devices being operated in such a way
that, when the clearing devices are operated simultaneously, each clearing device clears parts of a different piece of material, and
that each of the clearing devices respectively carries out only part of the clearing work to be carried out on a piece of material, and
   the clearing devices preferably also being operated or capable of being operated in such a way
that, of the clearing work to be carried out for a piece of material, the clearing work that is not carried out by one clearing device is or has been carried out by the other clearing devices,
that each of the clearing devices carries out part of the clearing work to be carried out for a piece of material,
that as many clearing devices as possible work simultaneously,
that the clearing devices work simultaneously for as long as possible,
that the extent of the clearing work to be carried out simultaneously by the clearing devices differs as little as possible,
that the dividing of the clearing work that each clearing device has to carry out on the pieces of material to be cleared at a given time is based on the clearing work that is to be carried out on the pieces of material to be cleared at the time by the clearing devices,
that the dividing of the clearing work that each clearing device has to carry out on the pieces of material to be cleared at a given time is based on the clearing work that is to be carried out on the next piece of material or the next pieces of material that is or are to be cleared after the pieces of material to be cleared at the time by the clearing devices,
that the clearing devices are moved independently of one another,
that each of the clearing devices has a clearing region within which it can be moved and can carry out clearing work, and that in each clearing region a piece of material of its own is placed,
that the pieces of material are transported into the first clearing region and further from clearing region to clearing region by a conveyor belt, and/or
that the conveyor belt is stopped when and for as long as one or more cutting devices is or are carrying out a cutting operation.

The cutting machine presented here and the method presented here prove to be advantageous irrespective of the details of the practical way in which they are realized.

### LIST OF DESIGNATIONS

1 supporting surface

2 material to be cut

31 bridge

32 bridge

41 cutting device

42 cutting device

101 supporting surface

121 first piece of material

122 second piece of material

131 first bridge

132 second bridge

141 first cutting device

142 second cutting device

A direction of movement of 31, 32, 131, 132

B direction of movement of 41, 42, 141, 142

C direction of movement of conveyor belt

1. A method for cutting pieces of material using a cutting machine having at least two cutting devices, which carry out cutting work simultaneously, wherein the cutting devices are operated such
that when the cutting devices are operated simultaneously, each of the cutting devices carries out its cutting work on a different piece of material, and
each of the cutting devices respectively carries out only part of the cutting work to be carried out on a piece of material.

2. The method as claimed in claim 1, wherein the cutting devices are operated such that each of the cutting devices carries out part of the cutting work to be carried out on a piece of material, and of the cutting work to be carried out on a piece of material, the cutting work that is not carried out by one cutting device is or has been carried out by at least one of the other cutting devices.

3. The method as claimed in claim 1, wherein the cutting devices are operated such that a maximum number of cutting devices work simultaneously for a maximum length of time.

4. The method as claimed in claim 1, wherein the cutting devices are operated such that the extent of the cutting work to be carried out simultaneously by the cutting devices differs by the least amount possible.

5. The method as claimed claim 1, wherein the dividing of the cutting work that each of the cutting devices carries out on the pieces of material to be cut at a given time is based on the cutting work that is to be carried out on the pieces of material being processed at the time by the cutting devices.

6. The method as claimed in claim 5, wherein the dividing of the cutting work that each of the cutting devices carries out on the pieces of material to be cut at a given time is based on the cutting work that is to be carried out on the next piece of material or the next pieces of material that is or are to be processed after the pieces of material being processed at the time by the cutting devices.

7. The method as claimed in claim 1, wherein the cutting work to be carried out on a piece of material is divided evenly between the cutting devices.

8. The method as claimed in claim 1, wherein the cutting work to be carried out on a piece of material is divided unevenly between the cutting devices.

9. The method as claimed in claim 1, wherein the pieces of material are transported one after the other by a conveyor belt into a cutting region of a first of the cutting devices that are present and further into a cutting region of a further of the cutting devices arranged upstream, and the conveyor belt is stopped when and for as long as one or more of the cutting devices is or are carrying out a cutting operation.

10. The method as claimed claim 1, wherein the controllable components of the cutting machine are controlled by one of a computer internal to the cutting machine and an external computer.

11. The method as claimed in claim 1, wherein clearing of cut-up pieces of material is performed in at least two clearing stations arranged one behind the other, each clearing station including a respective clearing device, the clearing devices being operated such
that, when the clearing devices are operated simultaneously, each clearing device clears parts of a different piece of material, and
each of the clearing devices respectively carries out only part of the cutting work to be carried out on a piece of material.

12. A cutting machine for cutting pieces of material and having at least two cutting devices, which carries out cutting work simultaneously, wherein the cutting machine works according to method of claim 1.

13. The cutting machine as claimed in claim 12, wherein each of the cutting devices has a cutting region within which it is movable and carries out cutting work, and the respective cutting regions are of such a size that a complete piece of material is placed within each of the cutting regions.

14. The cutting machine as claimed in claim 12, wherein each of the cutting devices has a cutting region within which is movable and carries out cutting work, and the cutting regions of the various cutting devices are arranged such that the cutting devices and/or cutting machine components carrying the cutting devices cannot collide, irrespective of the position of the respective cutting devices within the respective cutting regions.

15. The cutting machine as claimed in claim 12, wherein the cutting devices are arranged one behind the other, and a conveyor belt is provided, by which the pieces of material is transported from one of the cutting devices to another of the cutting devices.
